(19) United States
(12) Patent Application Publication
(10) Pub. No.: US 2018/0072958 A1
(43) Pub. Date: Mar. 15, 2018

(54) ISOPARAFFIN FROM ALKYLATE BOTTOMS

(71) Applicant: TOTAL MARKETING SERVICES, Puteaux (FR)

(72) Inventor: Kevin KELLY, Friendswood, TX (US)

(21) Appl. No.: 15/564,672

(22) PCT Filed: Apr. 5, 2016
(86) PCT No.: PCT/EP2016/057401

§ 371 Date: Oct. 5, 2017

(30) Foreign Application Priority Data
Apr. 6, 2015 (IB) PCT/IB2015/000656

(51) Int. Cl. C10G 7/02; B01D 3/14; C10G 29/20

(52) U.S. Cl. CPC C10G 7/02; B01D 3/14; C10G 29/205; C10G 2300/308; C10G 2400/02; C10G 2300/301; C10G 2300/1081

(57) ABSTRACT

A process includes distilling a refinery alkylate in a first distillation unit to form an alkylate stream containing a C₅ to C₉ fraction and a bottoms stream containing a C₉₊ fraction. The process includes distilling the bottoms stream in a second distillation unit to form a stream containing C₉₊ isoparaffins and a second bottoms stream. Products containing C₉₊ isoparaffins may be formed with the process. The products may be solvents, adhesives, inks, fluids, lubricants, or compositions. A system includes a first distillation unit, and a second distillation unit downstream of and in fluid communication with the first distillation unit.

### CROSS-REFERENCE TO RELATED APPLICATIONS

The present application claims priority from PCT/IB2015/000656, filed on Apr. 6, 2015, the entirety of which is incorporated herein by reference.

### FIELD

Embodiments of the present disclosure generally relate processes and systems for forming isoparaffins.

### BACKGROUND

Refinery alkylate may be produced by carbocation dimerization processes. Alkylation includes the transfer of an alkyl group from one molecule to another molecule. Transfer of the alkyl group may occur via alkyl carbocation, a free radical, a carbanion or a carbene, for example. Isoparaffins, such as isobutane, may be alkylated with alkenes, such as propene or butene, to produce alkylate. Refinery alkylate may include a mixture of paraffinic hydrocarbons. Alkylation may occur in the presence of a Brønsted acid catalyst, such as sulfuric acid or hydrofluoric acid, which protonates alkenes to produce reactive carbocations that alkylate isoparaffins.

Refinery alkylates produced by carbocation dimerization processes typically include C₆-C₉ isoparaffins, which may be used as a blend stock for gasoline. Refinery alkylates typically also include a quantity of larger carbon number oligomers, which may be formed during alkylation. The presence of such larger carbon number oligomers typically reduces the value of refinery alkylate for use as a blend stock for gasoline. Such larger carbon number oligomers may be highly branched C₉₊ hydrocarbons. Bottoms streams produced by distillation of refinery alkylates have been considered slops and have been used for fuel value.

### SUMMARY

An embodiment of the present disclosure includes a process. The process includes distilling a refinery alkylate in a first distillation unit to form an alkylate stream containing a C₅ to C₉ fraction and a bottoms stream containing a C₉₊ fraction. The process includes distilling the bottoms stream in a second distillation unit to form a stream containing C₉₊ isoparaffins and a second bottoms stream.

An embodiment of the present disclosure includes products. The products contain C₉₊ isoparaffins. The products are industrial solvents, cleaning solvents, solvents for resins, adhesives, solvents for polymerization, printing inks, metal working fluids, cutting fluids, rolling oils, EDM fluids, industrial lubricants, coating fluids and paint compositions.

An embodiment of the present disclosure includes a system. The system includes a first distillation unit adapted to distill a refinery alkylate to form an alkylate stream containing a C₅ to C₉ fraction and a bottoms stream containing a C₉₊ fraction. The system includes a second distillation unit adapted to receive the bottoms stream resulting from distillation of the refinery alkylate and distill the bottoms stream to form a stream containing C₉₊ isoparaffins and a second bottoms stream. The second distillation unit is downstream of and in fluid communication with the first distillation unit.

### BRIEF DESCRIPTION OF THE DRAWINGS

The present disclosure may be understood from the following detailed description when read with the accompanying figures.

FIG. 1 depicts a diagram of a process in accordance with one or more embodiments.

FIG. 2 depicts a plot of distillation temperature versus percent by volume of bottoms stream distilled in accordance with one or more embodiments.

### DETAILED DESCRIPTION

A detailed description will now be provided. The description includes specific embodiments, versions, and examples, but the disclosure is not limited to these embodiments, versions, or examples, which are included to enable a person having ordinary skill in the art to make and use the disclosure when that information is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

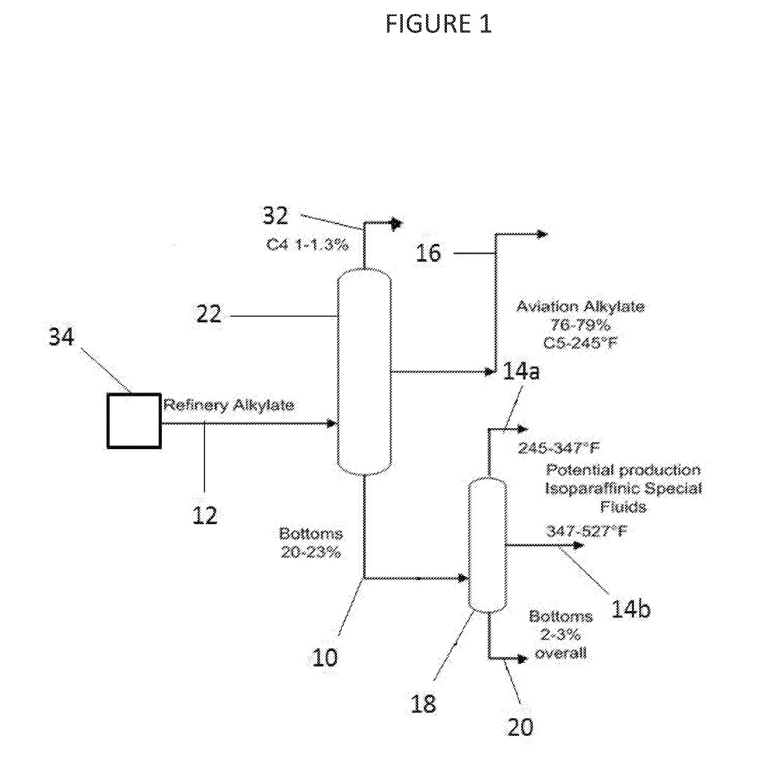

Certain embodiments relate to a process for forming isoparaffins. Referring to FIG. 1, the process may include obtaining bottoms stream 10 resulting from distillation of refinery alkylate 12.

Refinery alkylate 12 may include a mixture of high-octane, branched-chain paraffinic hydrocarbons. Refinery alkylate 12 may include one or more of a C₄ fraction, a C₅ fraction, a C₆ fraction, a C₇ fraction, a C₈ fraction, a C₉ fraction, a C₁₀ fraction, a C₁₁ fraction, or a C₁₁₊ fraction, each of which may be isoparaffin fractions. As is understood by one skilled in the art, a Cₓ₊ fraction, in which x is a numeral refers to a fraction that includes hydrocarbons, such as isoparaffins, having a chain length of at least x carbon atoms. Similarly, a Cₓ₋ fraction, in which x is a numeral refers to a fraction that includes hydrocarbons, such as isoparaffins, having a chain length of at most x carbon atoms. Thus, a C₁₁₊ fraction refers to a fraction that includes hydrocarbons, such as isoparaffins, having a chain length of at least 11 carbon atoms. For example, refinery alkylate 12 may include C₉₊ hydrocarbons, which may be highly branched, such as C₉₊ isoparaffins, C₁₀₊ isoparaffins, or C₁₁₊ isoparaffins, or C₆-C₉ isoparaffins. Branched isoparaffins in the C₉₊ carbon range may be useful as specialty fluids, such as solvents. Refinery alkylate 12 may include one or more of the components listed in Table 1 below.

Refinery alkylate 12 may be produced by a carbocation dimerization processes, such as in alkylation unit 34, in the presence of sulfuric acid or hydrofluoric acid, as is understood by one skilled in the art. The process may include distilling bottoms stream 10 to form one or more overhead streams 14a and 14b that include isoparaffins. Distillation of refinery alkylate 12 may increase the value of refinery alkylate 12 for use in gasoline, and may produce a valuable bottoms stream. A portion of bottoms stream 10, including C₉ isoparaffins or C₉₊ isoparaffins, may be used as specialty fluids, such as solvents.

Bottoms stream 10 may be distilled in distillation unit 18. Distillation unit 18 may be any distillation apparatus adapted to fractionate bottoms stream 10. For example and without limitation, distillation unit 18 may include one or more fractional distillation columns. In certain embodiments, bottoms stream 10 has not been subjected to modification or processing after production in additional distillation unit 22 and prior to distillation in distillation unit 18. For example and without limitation, in certain embodiments bottoms stream 10 has not been subjected to distillation after production in additional distillation unit 22 and prior to distillation in distillation unit 18.

Bottoms stream 10 may include C₈ isoparaffins, C₉ isoparaffins, C₁₀ isoparaffins, C₁₁ isoparaffins, or C₁₁₊ isoparaffins, for example. At least 50%, or at least 60%, or at least 70%, or at least 80%, or at least 90% by weight of bottoms stream 10 may be C₈-C₁₂ hydrocarbons, such as C₈-C₁₂ isoparaffins. At least 80, 85, 90, 95, or 99.5 weight percent of a C₁₁₋ fraction of bottoms stream may be isoparaffins. In certain embodiments, bottoms stream 10 does not include olefins. In certain embodiments, bottoms stream 10 includes a very low aromatics content, that is to say inferior to detection limit. In certain other embodiments, bottom stream 10 does not include aromatics. In certain embodiments, bottoms stream 10 includes a very low aromatics content and very low olefins content, that is to say inferior to detection limit. In certain other embodiments, bottoms stream 10 does not include olefins or aromatics. Bottoms stream 10 may include one or more of the components identified in Tables 7-11 below. Streams 14a and 14b may include C₉ isoparaffins, C₁₀ isoparaffins, C₁₁ isoparaffins, or C₁₁₊ isoparaffins, for example. Streams 14a and 14b may be removed from distillation unit 18. After distillation, streams 14a and 14b may be used as solvents, for example. While depicted as two cuts distilled at temperatures ranging from 120-175° C. and 175-275° C. in FIG. 1, bottoms stream 10 may be distilled to form any number of cuts with boiling points inclusive of streams 14a and 14b. Bottoms stream 10 may be distilled to form one or more cuts with boiling points ranging from 120-275° C., for example. The streams 14a and 14b that can be used as solvents also present an enhanced safety, due to the very low aromatics content. This makes them suitable for large variety of uses for example, in industrial solvents, in paints composition, in printing inks, in food processing industry and in metal working fluids, such as cutting fluids, EDM (electro discharge machining) fluids, rust preventives, coating fluids and aluminium rolling oils.

The streams 14a and 14b according to the process of the present invention may also be used as new and improved solvents, particularly as solvents for resins, adhesives and solvents for polymerization.

The streams 14a and 14b produced by the process of the present invention can be used as cleaning compositions for the removal of hydrocarbons such as for use in removing ink, more specifically in removing ink from printing. In all this foreseen uses, the Initial Boiling Point to Final Boiling Point range are selected according to the particular use and composition.

Distillation of bottoms stream 10 may form second bottoms stream 20. The weight percent of bottoms stream 20 based on a total weight of bottoms stream 10 may range from 0 to 10 weight percent, or 0.5 to 8 weight percent, or 1 to 6 weight percent, or 1.5 to 5 weight percent, or 2 to 3.5 weight percent, or 2 to 3 weight percent, for example. Second bottoms stream 20 may include a C₁₀-C₃₀ fraction, which may include isoparaffins. For example and without limitation, second bottoms stream 20 may include a C₃₀₋ fraction, or a C₂₅₋ fraction, or a C₂₂₋ fraction, or a C₂₀₋ fraction, or a C₁₀₊ fraction, or a C₁₁₊ fraction, or a C₁₂₊ fraction, or a C₁₂-C₂₂ fraction, or a C₁₅-C₂₀ fraction, each of which may be an isoparaffin fraction, for example.

Distillation of bottoms stream 10 may separate waste compounds from streams 14a and 14b, such as waste compounds produced during production of refinery alkylate 12. Waste compounds may include sulfur or sulfur containing compounds, fluorine or fluorine containing compounds, color bodies, organic compounds, or combinations thereof, for example. For example, in embodiments wherein refinery alkylate 12 is produced in the presence of sulfuric acid, bottoms stream 10 may include sulfur or sulfur containing compounds, color bodies, organic compounds, or combinations thereof. In embodiments wherein refinery alkylate 12 is produced in the presence of hydrofluoric acid, bottoms stream 10 may include fluorine or fluorine containing compounds, color bodies, organic compounds, or combinations thereof. Distillation of bottoms stream 10 may separate waste compounds from C₉₊ isoparaffins in streams 14a and 14b. Second bottoms stream 20 may include waste compounds, such as sulfur or sulfur containing compounds, fluorine or fluorine containing compounds, color bodies, organic compounds, or combinations thereof. In certain embodiments, waste compounds may be separated from C₉₊ isoparaffins without requiring additional procedures other than distillation of bottoms stream 10.

In certain embodiments, distillation of bottoms stream 10 forms intermediate fraction that includes isoparaffins, shown in FIG. 1 as stream 14b. Intermediate fraction may exit distillation unit 18 at a location between top stream 14a that includes isoparaffins and second bottoms stream 20. The combined weight percent of streams 14a and 14b based on the total weight of bottoms stream 10 may range from 80 to 100 weight percent, or 90 to 100 weight percent, or 94 to 99 weight percent, or 97 to 98 weight percent, for example.

Streams 14a and 14b may include fractions distilled at temperatures ranging from 100 to 350° C., or 110 to 325° C., or 115 to 300° C., or 118 to 275° C. For example and without limitation, stream 14a may include fractions distilled at temperatures ranging from 100 to 200° C., or 110 to 185° C., or 115 to 180° C., or 118 to 175° C., or 125 to 170° C., or 135 to 160° C., or 145° C. to 150° C. Stream 14b may include fractions distilled at temperatures ranging from 100 to 350° C., or 150 to 300° C., or 165 to 285° C., or 175 to 275° C., or 200 to 250° C., for example.

In certain embodiments, a volume percentage of steams 14a and 14b distilled at a temperature of 175° C. or less may range from 35 to 55 vol. %, or from 40 to 50 vol. %, or from 42 to 47 vol. %, or about 45 vol. %, based on a total volume of the streams 14a and 14b. A weight percentage of steams 14a and 14b distilled at a temperature of 175° C. or less may range from 35 to 55 wt. %, or from 40 to 50 wt. %, or from 42 to 47 wt. %, or about 44 wt. %, based on a total weight of the streams 14a and 14b. A volume percentage of steams 14a and 14b distilled at a temperature of 175° C. to 275° C. may range from 35 to 55 vol. %, or from 40 to 50 vol. %, or from 42 to 48 vol. %, or about 48 vol. %, based on the total volume of the streams 14a and 14b. A weight percentage of steams 14a and 14b distilled at a temperature of 175° C. to 275° C. may range from 35 to 60 wt. %, or from 40 to 55 wt. %, or from 42 to 50 wt. %, or about 49 vol. %, based on the total weight of the streams 14a and 14b. A volume percentage of steams 14a and 14b distilled at a temperature of 275° C. or higher may range from 1 to 15 vol. %, or from 2 to 12 vol. %, or from 3 to 10 vol. %, or from 4 vol. % to 8 vol. %, or about 6 vol. %, based on the total volume of the streams 14a and 14b. A weight percentage of steams 14a and 14b distilled at a temperature of 275° C. or higher may range from 1 to 15 wt. %, or from 2 to 12 wt. %, or from 3 to 10 wt. %, or from 3 to 8 wt. %, or about 7 wt. %, based on the total weight of the streams 14a and 14b.

In certain embodiments, distillation of bottoms stream 10 is performed at a temperature of less than 350° C., or less than 325° C., or less than 300° C., or at least 118° C., or at least 150° C., or at least 200° C., or at least 250° C., or at least 300° C. Distillation of bottoms stream 10 may be performed at a temperature ranging from 125° C. to 350° C., from 150° C. to 325° C., from 175° C. to 300° C., from 200° C. to 275° C., from 225° C. to 250° C., for example. At least 30 percent by volume of bottoms stream 10 may be distilled at a temperature of 175° C. or less, or 165° C. or less, or 150° C. or less. At least 50 percent by volume of bottoms stream 10 may be distilled at a temperature of 200° C. or less, or 175° C. or less, or 160° C. or less. At least 80 percent by volume of bottoms stream 10 may be distilled at a temperature of 225° C. or less, or 200° C. or less. At least 90 percent by volume of bottoms stream 10 may be distilled at a temperature of 250° C. or less, or 225° C. or less. One hundred percent by weight or substantially 100 percent by volume of bottoms stream 10 may be distilled at a temperature of 350° C. or less, or 325° C. or less, or 300° C. or less.

Obtaining bottoms stream 10 resulting from distillation of the refinery alkylate 12 may include distilling refinery alkylate 12 in additional distillation unit 22. Additional distillation unit 22 may be any distillation apparatus adapted to fractionate refinery alkylate 12. For example and without limitation, additional distillation unit 22 may include one or more fractional distillation columns. Distilling refinery alkylate 12 may form bottoms stream 10 and alkylate stream 16.

In certain embodiments, refinery alkylate 12 may be a full range alkylate product from alkylation unit 34 that has not been subjected to modification or processing after production in alkylation unit 34 and prior to distillation in additional distillation unit 22. For example and without limitation, in certain embodiments refinery alkylate 12 has not been subjected to distillation after production in alkylation unit 34 and prior to distillation in additional distillation unit 22. Refinery alkylate 12 may flow from a debutanizer of alkylation unit 34 into additional distillation column 22.

Alkylate stream 16 may include a C₅ to C₉ fraction, or a C₅ to C₈ fraction, or a C₆ to C₈, or a C₆ to C₉ fraction, each of which may be isoparaffin fractions, for example. Alkylate stream 16 may be distilled at a temperature ranging from 100° C. to 200° C., or 100° C. to 150° C., or 100° C. to 140° C., or 110° C. to 130° C., or 115° C. to 125° C., or about 118° C., for example. Alkylate stream 16 may be used in a blend to form gasoline. For example and without limitation, gasoline formed using alkylate stream 16 may be aviation gasoline, also referred to as avgas or aviation spirit, or conventional motor gasoline, also referred to as mogas. As is understood by one skilled in the art, formation of gasoline may include blending alkylate stream 16 with one or more additional cuts, additives, or combinations thereof

Distillation of refinery alkylate 12 may form a top stream 32. Top stream 32 may include a C₄ hydrocarbon fraction, such as a C₄ isoparaffin fraction. In certain embodiments, alkylate stream 16 may be an intermediate fraction between top stream 32 and bottoms stream 10. For example, alkylate stream 16 may exit additional distillation unit 22 at a location between the exit of top stream 32 and bottoms stream 10.

In certain embodiments, the weight percent of top stream 32 based on a total weight of refinery alkylate 12 may range from 0 to 5 weight percent, from 0.5 to 3.0 weight percent, from 0.75 to 2.0 weight percent, or from 1 to 1.3 weight percent, for example. The weight percent of alkylate stream 16 based on the total weight of refinery alkylate 12 may range from 45 to 99 weight percent, from 50 to 95 weight percent, from 60 to 85 weight percent, from 70 to 80 weight percent, or from 76 to 79 weight percent, for example. The weight percent of bottoms stream 10 based on the total weight of refinery alkylate 12 may range from 10 to 40 weight percent, from 15 to 20 weight percent, from 15 to 30 weight percent, from 18 to 25 weight percent, or from 20 to 23 weight percent, for example.

Distillation unit 18 may be downstream of and in fluid communication with additional distillation unit 22. Additional distillation unit 22 may be downstream of and in fluid communication with alkylation unit 34.

### EXAMPLES

The following examples show particular embodiments of the disclosure. It is understood that the examples are given by way of illustration and are not intended to limit the specification or the claims. All compositions percentages given in the examples are by weight, unless otherwise indicated.

### Example 1

### Refinery Alkylate Analysis

Four different samples of refinery alkylate produced in a sulfuric acid alkylation unit were analyzed for density and hydrocarbon content. Analysis of refinery alkylate included gas chromatography. Table 1 contains data for the four different refinery alkylates, including the density and mass percent of various constituents of the refinery alkylates.

TABLE 1
Example Refinery Alkylates

| | Alkylate-1 | Alkylate-2 | Alkylate-3 | Alkylate-4 |
|---|---|---|---|---|
| Density@ 15 C (g/ml) | 0.7090 | 0.7113 | 0.7084 | 0.7085 |
| Component | Mass % | Mass % | Mass % | Mass % |
| i-butane | 0.60 | 0.46 | 0.23 | 0.09 |
| n-butane | 1.93 | 1.62 | 2.62 | 2.38 |
| i-pentane | 3.84 | 3.05 | 3.28 | 3.33 |
| 2,3-dimethylbutane | 3.37 | 3.24 | 3.85 | 3.78 |
| 2-methylpentane | 0.95 | 0.93 | 1.09 | 1.12 |
| 3-methylpentane | 0.47 | 0.46 | 0.54 | 0.57 |
| 2,4-dimethylpentane | 2.92 | 2.89 | 3.03 | 3.06 |
| 2,2,3-trimethylbutane | 0.22 | 0.22 | 0.22 | 0.23 |
| 2-methylhexane | 0.27 | 0.27 | 0.36 | 0.27 |
| 2,3-dimethylpentane | 1.72 | 1.71 | 1.65 | 1.62 |
| 3-methylhexane | 0.19 | 0.20 | 0.19 | 0.19 |
| 2,2,4-trimethylpentane | 26.63 | 26.75 | 28.51 | 28.05 |
| 2,5-dimethylhexane | 3.92 | 4.07 | 3.74 | 3.87 |
| 2,2,3-trimethylpentane | 1.63 | 1.60 | 1.71 | 1.66 |
| 2,4-dimethylhexane | 3.30 | 3.44 | 3.22 | 3.29 |
| 2,3,4-trimethylpentane | 11.91 | 12.21 | 12.33 | 12.12 |
| 2,3,3-trimethylpentane | 14.08 | 14.13 | 14.58 | 14.20 |
| 2,3-dimethylhexane | 3.15 | 3.36 | 3.14 | 3.10 |
| 2-methyl-3-ethylpentane | 0.11 | 0.11 | 0.11 | 0.10 |
| 2-methylheptane | 0.09 | 0.10 | 0.09 | 0.09 |
| 3-methyl-3-ethylpentane | 0.26 | 0.28 | 0.26 | 0.25 |
| 3,4-dimethylhexane | 0.30 | 0.32 | 0.30 | 0.30 |
| 3-methylheptane | 0.07 | 0.07 | 0.07 | 0.07 |
| 2,2,5-trimethylhexane | 4.81 | 4.63 | 3.69 | 4.05 |
| n-octane | 0.14 | 0.14 | 0.11 | 0.12 |
| 2,2,4-trimethylhexane | 0.73 | 0.71 | 0.56 | 0.62 |
| 2,3,5-trimethylhexane | 0.09 | 0.09 | <0.06 | 0.08 |
| 4,4-dimethylheptane | 0.11 | 0.11 | 0.09 | 0.09 |
| 2,6-dimethylheptane | 0.31 | 0.31 | 0.25 | 0.26 |
| 2,3-dimethylheptane | 0.14 | 0.13 | 0.11 | 0.11 |
| I7 | 0.25 | 0.26 | 0.21 | 0.22 |
| I6 | 0.50 | 0.53 | 0.42 | 0.45 |
| I10 | 0.31 | 0.32 | 0.26 | 0.28 |
| I18 | 0.33 | 0.35 | 0.28 | 0.29 |
| I21 | 0.10 | 0.10 | 0.08 | 0.08 |
| I24 | 0.20 | 0.21 | 0.17 | 0.18 |
| I25 | 0.07 | 0.07 | <0.06 | <0.06 |
| I28 | 0.15 | 0.15 | 0.13 | 0.13 |
| I34 | 0.08 | 0.09 | <0.06 | 0.07 |
| I36 | <0.06 | <0.06 | <0.06 | 0.10 |
| I38 | 0.14 | 0.15 | 0.12 | 0.13 |
| I43 | 0.13 | 0.14 | 0.12 | 0.12 |
| n-undecane | 0.18 | 0.20 | 0.17 | 0.17 |

### Example 2

### Fractions Distilled From Refinery Alkylate

A bottoms stream resulting from distillation of a refinery alkylate produced in a sulfuric acid alkylation unit was subjected to distillation. Distillation of the bottoms stream was carried out in a column with about 10 theoretical plates. Table 2 includes the volume and weight percentages of fractions distilled from the bottoms stream of the refinery alkylate at temperatures of less than 175° C., from 175° C. to 275° C., and greater than 275° C.

TABLE 2
Weight and Volume Percentage of Fractions Distilled
From Refinery Alkylate

| Temperature | Volume Percentage | Weight Percentage |
|---|---|---|
| less than 175° C. | 45.8 vol. % | 44.3 wt. % |
| from 175° C. to 275° C. | 48.2 vol. % | 49.0 wt. % |
| greater than 275° C. | 6.0 vol. % | 6.7 wt. % |

### Example 3

### Distillation Curve of an Alkylate Bottoms Stream

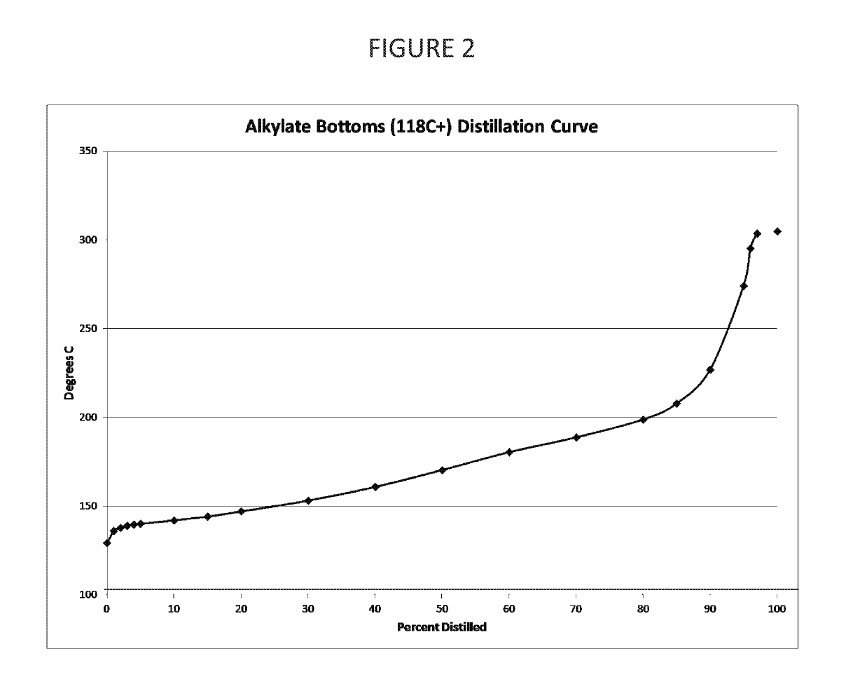

A bottoms stream resulting from distillation of a refinery alkylate produced in a sulfuric acid alkylation unit was subjected to distillation. FIG. 2 depicts a distillation curve for the distillation, which was performed at a temperature ranging from 118° C. to under 325° C.

### Example 4

### Sulfur Content of Alkylate Bottoms Stream

A 100 milliliter sample of a bottoms stream resulting from distillation of a refinery alkylate produced in a sulfuric acid alkylation unit was subjected to distillation in a spinning band column at temperatures of 118° C. and above, resulting in overhead fractions and a bottoms fraction. The bottoms stream had a density of about 0.7507 g/ml. Overhead fractions were taken at 50, 60, 70, and 83.5 volume percent distilled. Due to the small sample size of the bottoms stream, collection of an overhead fraction beyond 83.5 volume percent was not performed, and the remainder was collected as a bottoms fraction. The sulfur content data for the fractions are shown in Table 3. This example demonstrates that most sulfur remains in the bottoms fraction when the bottoms stream is subjected to distillation. While this example analyzes sulfur content present in refinery alkylate produced in a sulfuric acid alkylation unit, it is expected that similar results would be obtained with regards to fluorine present in refinery alkylate produced in a hydrofluoric acid alkylation unit.

TABLE 3
Weight and Volume Percentage of
Fractions Distilled From Refinery Alkylate

| | | | | | | 83.5- |
|---|---|---|---|---|---|---|
| | | 50 | 50-60 | 60-70 | 70-83.5 | 100 |
| | | volume | volume | volume | volume | volume |
| | | %-over- | %-over- | %-over- | %-over- | %- |
| | Bottoms | head | head | head | head | bottoms |
| Sample | Stream | fraction | fraction | fraction | fraction | fraction |
| Sulfur | | | | | | 0.03 |
| Content | | | | | | weight |
| (weight | | | | | | percent |
| percent) | | | | | | |
| Sulfur | 174 | <0.5 | 0.5 ppm | <0.5 ppm | 1.9 ppm | |
| Content | ppm | ppm | | | | |
| (ppm) | | | | | | |

A separate sample of the same bottoms stream was subjected to distillation in accordance with ASTM D86-12. Table 4 shows the temperatures at various volume percentages distilled during this sample. The conditions of distillation included a barometric pressure of 760 mmHg, an initial boiling point of 129.3° C., and a final boiling point of 304.9° C.

TABLE 4
Temperatures at Volume Percentages Distilled

| Volume Percent Distilled | Temperature |
|---|---|
| 1% by volume | 136.1° C. |
| 2% by volume | 137.9° C. |
| 3% by volume | 139° C. |
| 4% by volume | 139.7° C. |
| 5% by volume | 140.1° C. |
| 10% by volume | 142.1° C. |
| 15% by volume | 144.2° C. |
| 20% by volume | 147.1° C. |
| 30% by volume | 153.2° C. |
| 40% by volume | 160.9° C. |
| 50% by volume | 170.4° C. |
| 60% by volume | 180.5° C. |
| 70% by volume | 188.8° C. |
| 80% by volume | 198.9° C. |
| 85% by volume | 207.9° C. |
| 90% by volume | 227° C. |
| 95% by volume | 274.3° C. |
| 96% by volume | 295.2° C. |
| 97% by volume | 303.7° C. |

Additionally, a distillation in accordance with ASTM D2892 was performed on a 5,800 gram sample the bottoms stream. A fraction weighing about 1,179 grams was collected, constituting about 20.33 weight percent of the sample. The sample had a specific gravity of about 0.7514 g/ml and a measured density of about 0.7507 g/ml at a temperature of 15° C.

### Example 5

### Distillation of Alkylate Bottoms Stream

A sample of a bottoms stream resulting from distillation of a refinery alkylate produced in a sulfuric acid alkylation unit was obtained. The bottoms stream had a density at 15° C. of 750.6 kg/m³ as determined in accordance with ISO 12185, a flash point of 25° C. as determined in accordance with ISO 13736, a Colour Saybolt value of −2 as determined in accordance with NF M 07003, a Brome Index of 0 as determined in accordance with ASTM D2710, and a sulfur content of 48 ppm as determined in accordance with NF M07059.

Liquid chromatography with high performance detection by differential refractometry was performed in accordance with NF EN 12916, and the bottoms stream was determined to have a mono-aromatics content of less than 0.1 percent by mass, a di-aromatics content of less than 0.1 percent by mass, a tri-aromatics content of less than 0.1 percent by mass, a poly-aromatics content of less than 0.1 percent by mass, and a total aromatics content of less than 0.1 percent by mass. The bottoms stream was clear and yellow in appearance as determined by visual inspection.

The bottoms stream was subjected to distillation in accordance with ASTM D86-12. Table 5 lists the temperatures at differing percent distillations of the bottoms stream.

TABLE 5
Temperatures at Volume Percentages Distilled

| Volume Percent Distilled | Standard | Temperature |
|---|---|---|
| Initial boiling point | EN ISO 3405 | 134.1° C. |
| 2% by volume | EN ISO 3405 | 140.7° C. |
| 5% by volume | EN ISO 3405 | 144.7° C. |
| 10% by volume | EN ISO 3405 | 146.6° C. |
| 20% by volume | EN ISO 3405 | 152.3° C. |
| 30% by volume | EN ISO 3405 | 157.4° C. |
| 40% by volume | EN ISO 3405 | 162.7° C. |
| 50% by volume | EN ISO 3405 | 171.3° C. |
| 60% by volume | EN ISO 3405 | 180.2° C. |
| 65% by volume | EN ISO 3405 | 185.3° C. |
| 70% by volume | EN ISO 3405 | 191.0° C. |
| 80% by volume | EN ISO 3405 | 200.7° C. |
| 90% by volume | EN ISO 3405 | 227.7° C. |
| 95% by volume | EN ISO 3405 | 260.7° C. |
| Dry Point | EN ISO 3405 | 283.7° C. |

A simulated distillation in accordance with ASTM D 2887 was performed for the bottoms stream. The results of the simulated distillation are presented in Table 6.

TABLE 6
Simulated Distillation

| Volume Percent Distilled | Standard | Temperature |
|---|---|---|
| Initial Point | ASTM D 2887 | 132.7° C. |
| 10% by volume | ASTM D 2887 | 136.9° C. |
| 20% by volume | ASTM D 2887 | 143.1° C. |
| 30% by volume | ASTM D 2887 | 151.9° C. |
| 50% by volume | ASTM D 2887 | 178.6° C. |
| 70% by volume | ASTM D 2887 | 181.9° C. |
| 80% by volume | ASTM D 2887 | 191.7° C. |
| 90% by volume | ASTM D 2887 | 134.6° C. |
| Final Point | ASTM D 2887 | 308.7° C. |

Results for carbon analysis of bottoms stream in accordance with ASTM D 2887 are presented in Table 7.

TABLE 7
Carbon Analysis of Bottoms Stream

| | | Percent by Weight of |
|---|---|---|
| Number of Carbon Atoms | Standard | Bottoms Stream |
| 8 | ASTM D 2887 | 16.4 wt. % |
| 9 | ASTM D 2887 | 19.9 wt. % |
| 10 | ASTM D 2887 | 10.7 wt. % |
| 11 | ASTM D 2887 | 28.8 wt. % |
| 12 | ASTM D 2887 | 10.6 wt. % |
| 13 | ASTM D 2887 | 2.6 wt. % |
| 14 | ASTM D 2887 | 3.8 wt. % |
| 15 | ASTM D 2887 | 1.7 wt. % |
| 16 | ASTM D 2887 | 1.2 wt. % |
| 17 | ASTM D 2887 | 1.2 wt. % |
| 18 | ASTM D 2887 | 0.7 wt. % |
| 19 | ASTM D 2887 | 0.6 wt. % |
| 20 | ASTM D 2887 | 0.6 wt. % |
| 21 | ASTM D 2887 | 0.3 wt. % |
| 22 | ASTM D 2887 | 0.3 wt. % |
| Total | | 99.4 wt. % |

The data in Table 7 demonstrates that a majority of the contents of the bottoms stream is within the C₈-C₁₂ range.

### Example 6

### Analysis of Bottoms Stream

Two-dimensional gas chromatography was performed a sample of a bottoms stream resulting from distillation of a refinery alkylate produced in a sulfuric acid alkylation unit. Contents of the bottoms stream are presented in Table 8.

TABLE 8
Contents of Bottoms Stream

| Number of | | | | | |
|---|---|---|---|---|---|
| Carbon | | N- | | | |
| Atoms | Isoparaffins | paraffins | Naphthenes | Aromatics | Total |
| 7 | — | — | — | — | — |
| 8 | 8.07 | 0.01 | — | — | 8.07 |
| 9 | 22.75 | 0.03 | — | — | 22.78 |
| 10 | 17.62 | 0.02 | — | — | 17.64 |
| 11 | 28.48 | 0.32 | — | — | 28.80 |
| 12 | — | — | — | — | — |
| Total | 76.92 | 0.37 | — | — | 77.29 |
| Non- | | | | | 0.11 |
| identified | | | | | |
| components | | | | | |
| <C₁₁ | | | | | |
| Non- | | | | | 22.60 |
| identified | | | | | |
| components | | | | | |
| >C₁₁ | | | | | |

### Example 7

### Analysis of Cuts from Alkylate Bottoms Stream Distillation

A bottoms stream resulting from distillation of a refinery alkylate produced in a sulfuric acid alkylation unit was obtained. The bottoms stream was determined to have an API gravity at 15° C. of 56.8° API and a relative density at 15/15° C. of 0.7516, as determined in accordance with ASTM D5002. Various samples of bottoms steam, as detailed below, were subjected to distillation in a 15 theoretical plate column in accordance with ASTM D2892 at different cut points (Samples A, B, C, D, and E).

### Sample A

A portion of the bottoms stream was subjected to distillation in a 15 theoretical plate column in accordance with ASTM D2892 at a cut point of below 155° C. The cut resulting from distillation of the bottoms stream taken at below 155° C. was identified as Sample A. Sample A was determined to have a relative density at 15/15° C. of 0.7227 and an API gravity at 15° C. of 64.3° API, as determined in accordance with ASTM D4052 using a Digital Density Meter. Benzene and Toluene contents were determined to be less than 0.10 volume percent using gas chromatography in accordance with ASTM D3606.

Dry vapor pressure equivalent, ASTM and EPA were determined to both be less than 1.00 psi using Vapor Pressure of Petroleum Products (Mini-Method) in accordance with ASTM D5191, with a container size of 1 liter. Sample A was observed to be not hazy. The corrected flash point of Sample A was determined to be about 30° C. in accordance with ASTSM D56 using a Tag Closed Cup Tester.

Multi-dimensional gas chromatography through 200° C. was performed in accordance with ASTM D5443 to determine paraffin, naphthene, and aromatic hydrocarbon contents. The results of the multi-dimensional gas chromatography are presented in Table 9.

TABLE 9
Multi-dimensional gas chromatography through 200° C. - Sample A

| Component | Content (volume percent) | |
|---|---|---|
| benzene | <0.05 | volume percent |
| C₆ naphthenes | <0.05 | volume percent |
| C₆ paraffins | <0.05 | volume percent |
| Toluene | 0.15 | volume percent |
| C₇ naphthenes | <0.05 | volume percent |
| C₇ paraffins | <0.05 | volume percent |
| C₈ aromatics | 0.07 | volume percent |
| C₈ naphthenes | 0.07 | volume percent |
| C₈ paraffins | 25.77 | volume percent |
| C₉ aromatics | <0.05 | volume percent |
| C₉ naphthenes | 0.43 | volume percent |
| C₉ paraffins | 54.28 | volume percent |
| C₁₀ aromatics | <0.05 | volume percent |
| C₁₀ naphthenes | 0.21 | volume percent |
| C₁₀ paraffins | 18.11 | volume percent |
| C₁₁ aromatics | <0.05 | volume percent |
| C₁₁ naphthenes | <0.05 | volume percent |
| C₁₁ paraffins | 0.72 | volume percent |
| Total paraffins | 98.89 | volume percent |
| Total naphthenes | 0.72 | volume percent |
| Total aromatics | 0.25 | volume percent |
| >200° C. | 0.15 | volume percent |

### Sample B

A portion of the bottoms stream was subjected to distillation in a 15 theoretical plate column in accordance with ASTM D2892 at a cut point ranging from 155-175° C. The cut resulting from distillation of the bottoms stream taken at 155-175° C. was identified as Sample B. Sample B was determined to have a relative density at 15/15° C. of 0.7436 and an API gravity at 15° C. of 58.8° API, as determined in accordance with ASTM D4052 using a Digital Density Meter. Benzene and Toluene contents were determined to be less than 0.10 volume percent using gas chromatography in accordance with ASTM D3606. The flash point of Sample B was determined to be about 40° C. in accordance with ASTSM D93 using a Pensky-Martens Closed Cup Flash Point Procedure.

Multi-dimensional gas chromatography through 200° C. was performed in accordance with ASTM D5443 to determine paraffin, naphthene, and aromatic hydrocarbon contents. The results of the multi-dimensional gas chromatography are presented in Table 10.

TABLE 10
Multi-dimensional gas chromatography through 200° C. - Sample B

| Component | Content (volume percent) | |
|---|---|---|
| benzene | <0.05 | volume percent |
| C₆ naphthenes | <0.05 | volume percent |
| C₆ paraffins | <0.05 | volume percent |
| Toluene | <0.05 | volume percent |
| C₇ naphthenes | <0.05 | volume percent |
| C₇ paraffins | <0.05 | volume percent |
| C₈ aromatics | 0.19 | volume percent |
| C₈ naphthenes | <0.05 | volume percent |
| C₈ paraffins | <0.05 | volume percent |
| C₉ aromatics | 0.20 | volume percent |
| C₉ naphthenes | 0.14 | volume percent |
| C₉ paraffins | 1.62 | volume percent |
| C₁₀ aromatics | <0.05 | volume percent |
| C₁₀ naphthenes | 2.30 | volume percent |
| C₁₀ paraffins | 34.07 | volume percent |
| C₁₁ aromatics | <0.05 | volume percent |
| C₁₁ naphthenes | 0.34 | volume percent |
| C₁₁ paraffins | 54.28 | volume percent |
| Total paraffins | 90.01 | volume percent |
| Total naphthenes | 3.46 | volume percent |
| Total aromatics | 0.41 | volume percent |
| >200° C. | 6.11 | volume percent |

### Sample C

A portion of the bottoms stream was subjected to distillation in a 15 theoretical plate column in accordance with ASTM D2892 at a cut point ranging from175-215° C. The cut resulting from distillation of the bottoms stream taken at 175-215° C. was identified as Sample C. Sample C was determined to have a relative density at 15/15° C. of 0.7596 and an API gravity at 15° C. of 54.8° API, as determined in accordance with ASTM D4052 using a Digital Density Meter. Benzene and Toluene contents were determined to be less than 0.10 volume percent using gas chromatography in accordance with ASTM D3606. The flash point of Sample C was determined to be about 57° C. in accordance with ASTSM D93 using a Pensky-Martens Closed Cup Flash Point Procedure.

Multi-dimensional gas chromatography through 200° C. was performed in accordance with ASTM D5443 to determine paraffin, naphthene, and aromatic hydrocarbon contents. The results of the multi-dimensional gas chromatography are presented in Table 11.

TABLE 11
Multi-dimensional gas chromatography through 200° C. - Sample C

| Component | Content (volume percent) | |
|---|---|---|
| benzene | <0.05 | volume percent |
| C₆ naphthenes | <0.05 | volume percent |
| C₆ paraffins | <0.05 | volume percent |
| Toluene | <0.05 | volume percent |
| C₇ naphthenes | <0.05 | volume percent |
| C₇ paraffins | <0.05 | volume percent |
| C₈ aromatics | <0.05 | volume percent |
| C₈ naphthenes | <0.05 | volume percent |
| C₈ paraffins | <0.05 | volume percent |
| C₉ aromatics | 0.55 | volume percent |
| C₉ naphthenes | <0.05 | volume percent |
| C₉ paraffins | <0.05 | volume percent |
| C₁₀ aromatics | 5.65 | volume percent |
| C₁₀ naphthenes | 0.20 | volume percent |
| C₁₀ paraffins | 0.69 | volume percent |
| C₁₁ aromatics | <0.05 | volume percent |
| C₁₁ naphthenes | 0.83 | volume percent |
| C₁₁ paraffins | 15.24 | volume percent |
| Total paraffins | 15.99 | volume percent |
| Total naphthenes | 11.44 | volume percent |
| Total aromatics | 6.24 | volume percent |
| >200° C. | 66.34 | volume percent |

### Sample D

A portion of the bottoms stream was subjected to distillation in a 15 theoretical plate column in accordance with ASTM D2892 at a cut point ranging from 215-275° C. The cut resulting from distillation of the bottoms stream taken at 215-275° C. was identified as Sample D. Sample D was determined to have a relative density at 15/15° C. of 0.7866 and an API gravity at 15° C. of 48.4° API, as determined in accordance with ASTM D4052 using a Digital Density Meter. Benzene and Toluene contents were determined to be less than 0.10 volume percent using gas chromatography in accordance with ASTM D3606. The corrected flash point of Sample D was determined to be about 93° C. in accordance with ASTSM D93 using a Pensky-Martens Closed Cup Flash Point Procedure. Multi-dimensional gas chromatography through 200° C. in accordance with ASTM D5443 to determine paraffin, naphthene, and aromatic hydrocarbon contents was not applicable to Sample D.

### Sample E

A portion of the bottoms stream was subjected to distillation in a 15 theoretical plate column in accordance with ASTM D2892 at a cut point ranging above 275° C. The cut resulting from distillation of the bottoms stream taken at above 275° C. as identified as Sample E. Sample E was determined to have a relative density at 15/15° C. of 0.8270 and an API gravity at 15° C. of 39.6° API, as determined in accordance with ASTM D4052 using a Digital Density Meter.

Analysis of Samples A-E, as detailed above, demonstrates that as the cut point is increased progressively heavier cuts are obtained by distillation of the bottoms stream resulting from distillation of the refinery alkylate.

### EMBODIMENTS

In addition to the forgoing description, the following enumerated embodiments are also within the scope of the present disclosure.

1. A process comprising: obtaining a bottoms stream resulting from distillation of a refinery alkylate; and distilling the bottoms stream to form a stream comprising isoparaffins.

2. The process according to embodiment 1, wherein the bottoms stream comprises C₉₊ isoparaffins.

3. The process according to embodiment 1 or embodiment 2, wherein the stream comprising isoparaffins comprises C₉₊ isoparaffins.

4. The process according to any one of embodiments 1 to 3, wherein the bottoms stream does not comprise olefins, does not comprise aromatics, or does not comprise both olefins and aromatics.

5. The process according to any one of embodiments 1 to 4, wherein distilling the bottoms stream forms a second bottoms stream.

6. The process according to embodiment 5, wherein distilling the bottoms stream forms an intermediate fraction comprising isoparaffins, wherein the intermediate fraction is intermediate of the stream comprising isoparaffins and the second bottoms stream.

7. The process according to any one of embodiments 1 to 6, wherein distilling the bottoms stream is performed at a temperature of less than 350° C.

8. The process according to any one of embodiments 1 to 7, wherein obtaining the bottoms stream resulting from distillation of the refinery alkylate comprises distilling the refinery alkylate in a distillation unit to form an alkylate stream and the bottoms stream.

9. The process according to embodiment 8, wherein the refinery alkylate comprises C₆-C₉₊ isoparaffins.

10. The process according to embodiment 8 or embodiment 9, wherein the refinery alkylate is produced by alkylation of isoparaffin with alkene in the presence of sulfuric acid or hydrofluoric acid.

11. The process according to any one of embodiments 8 to 10, wherein distilling the refinery alkylate forms a top stream comprising a C₄ hydrocarbon fraction, wherein the alkylate stream exits the distillation unit at a location between the exit of the top stream comprising the C₄ hydrocarbon fraction and the bottoms stream.

12. The process according to any one of embodiments 8 to 11, further comprising forming a gasoline with the alkylate stream.

13. A process comprising: obtaining a bottoms stream resulting from distillation of a refinery alkylate; and distilling the bottoms stream in a distillation unit to form a stream comprising isoparaffins, wherein the distillation unit is downstream of and in fluid communication with an additional distillation unit adapted to distill the refinery alkylate to form the bottoms stream and an alkylate stream.

14. The process according to embodiment 13, wherein the additional distillation unit is downstream of and in fluid communication with an alkylation unit adapted to alkylate isoparaffins in the presence of alkenes to form the refinery alkylate.

15. The process according to embodiment 13 or embodiment 14, further comprising forming a gasoline with the alkylate stream.

16. The process according to any one of embodiments 13 to 15, wherein the stream comprising isoparaffins comprises C₉₊ isoparaffins.

17. A product comprising the C₉₊ isoparaffins according to embodiment 16, wherein the product is selected from the group consisting of industrial solvents, cleaning solvents, solvents for resins, adhesives, solvents for polymerization, printing inks, metal working fluids, cutting fluids, rolling oils, EDM fluids, industrial lubricants, coating fluids and paint compositions.

18. A system comprising: a distillation unit adapted to receive a bottoms stream resulting from distillation of a refinery alkylate and distill the bottoms stream to form a stream comprising isoparaffins.

19. The system according to embodiment 18, wherein the distillation unit is downstream of and in fluid communication with an additional distillation unit, wherein the additional distillation unit is adapted to distill the refinery alkylate to form the bottoms stream.

20. The system according to embodiment 19, wherein the additional distillation unit is downstream of and in fluid communication with an alkylation unit, wherein the alkylation unit is adapted to alkylate isoparaffins in the presence of alkenes to form the refinery alkylate.

21. The system according to any one of embodiments 18 to 20, wherein the stream comprising isoparaffins comprises C₉₊ isoparaffins.

Depending on the context, all references herein to the “disclosure” may in some cases refer to certain specific embodiments only. In other cases it may refer to subject matter recited in one or more, but not necessarily all, of the claims. While the foregoing is directed to embodiments, versions and examples of the present disclosure, which are included to enable a person of ordinary skill in the art to make and use the disclosures when the information in this patent is combined with available information and technology, the disclosures are not limited to only these particular embodiments, versions and examples. Other and further embodiments, versions and examples of the disclosure may be devised without departing from the basic scope thereof and the scope thereof is determined by the claims that follow.

1. A process comprising:
distilling a refinery alkylate in a first distillation unit to form an alkylate stream comprising a C₅ to C₉ fraction and a bottoms stream comprising a C₉₊ fraction; and
distilling the bottoms stream in a second distillation unit to form a stream comprising C₉ isoparaffins and a second bottoms stream.

2. The process according to claim 1, wherein the bottoms stream comprises C₉₊ isoparaffins.

3. The process according to claim 1, wherein the stream comprising isoparaffins comprises C₁₀₊ isoparaffins.

4. The process according to claim 1, wherein the bottoms stream does not comprise olefins, does not comprise aromatics, or does not comprise both olefins and aromatics.

5. The process according to claim 1, wherein the second bottoms stream comprises a C₁₀ to C₃₀ fraction.

6. The process according to claim 1, wherein distilling the bottoms stream forms an intermediate fraction comprising isoparaffins, wherein the intermediate fraction exits the second distillation unit at a location between the stream comprising C₉₊ isoparaffins and the second bottoms stream.

7. The process according to claim 1, wherein distilling the bottoms stream is performed at a temperature of less than 350° C.

8. The process according to claim 1, wherein the refinery alkylate comprises C₆-C₉₊isoparaffins.

9. The process according to claim 1, wherein the refinery alkylate is produced by alkylation of isoparaffin with alkene in the presence of sulfuric acid.

10. The process according to claim 1, wherein the refinery alkylate is produced by alkylation of isoparaffin with alkene in the presence of hydrofluoric acid.

11. The process according to claim 1, wherein distilling the refinery alkylate forms a top stream comprising a C₄ hydrocarbon fraction, wherein the alkylate stream exits the first distillation unit at a location between the exit of the top stream comprising the C₄ hydrocarbon fraction and the bottoms stream,

12. The process according to claim 1, further comprising forming a gasoline with the alkylate stream.

13. The process according to claim 1, wherein the second distillation unit is downstream of and in fluid communication with the first distillation unit.

14. The process according to claim 13, wherein the first distillation unit is downstream of and in fluid communication with an alkylation unit adapted to alkylate isoparaffins in the presence of alkenes to form the refinery alkylate.

15. The process according to claim 1, wherein the stream comprising C₉₊ isoparaffins comprises isoparaffins.

16. The process according to claim 1, further comprising forming a product with the stream comprising C₉₊ isoparaffins, wherein the product is selected from the group consisting of industrial solvents, cleaning solvents, solvents for resins, adhesives, solvents for polymerization, printing inks, metal working fluids, cutting fluids, rolling oils, EDM fluids, industrial lubricants, coating fluids and paint compositions.

17. A product comprising the C₉₊ isoparaffins formed according to claim 16, wherein the product is selected from the group consisting of industrial solvents, cleaning solvents, solvents for resins, adhesives, solvents for polymerization, printing inks, metal working fluids, cutting fluids, rolling oils, EDM fluids, industrial lubricants, coating fluids and paint compositions.

18. A system comprising:
a first distillation unit adapted to distill a refinery alkylate to form an alkylate stream comprising a C₅ to C₉ fraction and a bottoms stream comprising a C₉₊ fraction; and
a second distillation unit adapted to receive the bottoms stream resulting from distillation of the refinery alkylate and distill the bottoms stream to form a stream comprising C₉₊ isoparaffins and a second bottoms stream, wherein the second distillation unit is downstream of and in fluid communication with the first distillation unit.

19. The system of claim 18, wherein the first distillation unit is downstream of and in fluid communication with an alkylation unit, wherein the alkylation unit is adapted to alkylate isoparaffins in the presence of alkenes to form the refinery alkylate.

20. The system of claim 18, wherein the stream comprising C₉₊ isoparaffins comprises C₁₀₊ isoparaffins.
